(19) United States
(12) Patent Application Publication
(10) Pub. No.: US 2022/0011125 A1
(43) Pub. Date: Jan. 13, 2022

(54) NAVIGATION METHOD, ELECTRONIC DEVICE, AND STORAGE MEDIUM

(71) Applicant: Beijing Baidu Netcom Science And Technology Co Ltd, Beijing (CN)

(72) Inventors: Tingting Ge, Beijing (CN); Zhao Li, Beijing (CN); Xun Gan, Beijing (CN)

(73) Assignee: Beijing Baidu Netcom Science And Technology Co Ltd, Beijing (CN)

(21) Appl. No.: 17/481,813

(22) Filed: Sep. 22, 2021

(30) Foreign Application Priority Data
Oct. 9, 2020 (CN) 202011073924.6

(51) Int. Cl. G01C 21/34; G08G 1/0969; G08G 1/14

(52) U.S. Cl. CPC G01C 21/3476; G08G 1/144; G08G 1/0969

(57) ABSTRACT

A navigation method, an electronic device, and a storage medium, which are related to a field of artificial intelligence, such as depth learning, maps, and navigation. The specific implementation scheme includes: obtaining a parking space located in an indoor parking lot in response to an operation acquired based on a map application, generating an indoor-outdoor navigation route in the map application by taking the parking space as a destination address in the indoor-outdoor navigation route, and navigating a vehicle driven by a user to the parking space according to the indoor-outdoor navigation route.

### CROSS-REFERENCE TO RELATED APPLICATIONS

This application claims priority to Chinese patent application No. 202011073924.6, entitled “Navigation Method and Apparatus, Electronic Device, and Storage Medium”, filed with the Chinese Patent Office on Oct. 9, 2020, which is hereby incorporated by reference in its entirety.

### TECHNICAL FIELD

The application relates to a field of artificial intelligence. The application relates particularly to fields of depth learning, maps, navigation, and the like.

### BACKGROUND

The convenience and the high efficiency of information processing are significant for users in the era of data explosion, electronic devices such as a portable terminal, a vehicle-mounted terminal, a mobile phone terminal, and the like are more intelligent than before, and the analytical capability of a chip is also stronger. The convenience and the high efficiency of processing various information can be improved by developing respective terminals or by implanting various applications of third parties into respective terminals, so that easy-to-use simplified information processing that satisfies a user's interactive experience can be used to meet all aspects of a user's life.

### SUMMARY

According to the present disclosure, it is provided a navigation method and apparatus, an electronic device, and a storage medium.

According to an aspect of the present disclosure, it is provided a navigation method, including:

obtaining a parking space located in an indoor parking lot in response to an operation acquired based on a map application;

generating an indoor-outdoor navigation route in the map application by taking the parking space as a destination address in the indoor-outdoor navigation route; and

navigating a vehicle driven by a user to the parking space according to the indoor-outdoor navigation route.

According to another aspect of the present disclosure, there is provided a navigation apparatus, including:

a response module for obtaining a parking space located in an indoor parking lot in response to an operation acquired based on a map application;

a route planning module for generating an indoor-outdoor navigation route in the map application by taking the parking space as a destination address in the indoor-outdoor navigation route; and

a navigation module for navigating a vehicle driven by a user to the parking space according to the indoor-outdoor navigation route.

According to another aspect of the present disclosure, there is provided an electronic device, including:

at least one processor; and

a memory communicatively connected to the at least one processor, wherein

the memory stores instructions executable by the at least one processor, and the instructions are executed by the at least one processor to enable the at least one processor to execute the method provided by any one of embodiments of the present disclosure.

According to another aspect of the present disclosure, there is provided a non-transitory computer-readable storage medium storing computer instructions, wherein the computer instructions, when executed by a computer, cause the computer to execute the method provided by any one of embodiments of the present disclosure.

It should be understood that content in this section is not intended to identify key or critical features of embodiments of the present disclosure, nor is it intended to limit the scope of the present disclosure. Other features of the present disclosure will become readily apparent from the following description.

### BRIEF DESCRIPTION OF THE DRAWINGS

The drawings are used to better understand the scheme and do not constitute a limitation to the present disclosure. In the drawings:

FIG. 1 is a schematic flowchart of a navigation method applied in a first embodiment of the present disclosure;

FIG. 2 is a schematic diagram of a navigation route planning including a parking space applied in the first embodiment of the present disclosure;

FIG. 3 is a schematic flowchart of a navigation method according to a second embodiment of the present disclosure;

FIG. 4 is a schematic flowchart of a navigation method according to a third embodiment of the present disclosure;

FIG. 5 is a schematic diagram of an application example of a navigation method according to a fourth embodiment of the present disclosure;

FIG. 6 is a schematic structural diagram showing a navigation apparatus according to a fifth embodiment of the present disclosure; and

FIG. 7 is a block diagram of an electronic device for implementing a navigation method of an embodiment of the present disclosure.

### DETAILED DESCRIPTION

Exemplary embodiments of the present disclosure will be described below in combination with drawings, including various details of embodiments of the present disclosure to facilitate understanding, which should be considered as exemplary only. Therefore, those of ordinary skill in the art should realize that various changes and modifications can be made to the embodiments described herein without departing from the scope and spirit of the present disclosure. Likewise, descriptions of well-known functions and structures are omitted in the following description for clarity and conciseness.

The term “and/or”, as used herein, is merely an association that describes an associated object, meaning that there may be three types of relationships, e.g., A and/or B, that may represent three cases of: A existing alone, A and B existing simultaneously, and B existing alone. As used herein, the term “at least one” means any one of a variety or any combination of at least two of a variety, e.g., including at least one of A, B, and C, that may represent including any one or more elements selected from the group consisting of A, B, and C, The terms “first” and “second” are used herein to refer to and distinguish between a plurality of similar technical terms, and are not intended to be limiting in order or to define only two, e.g., a first feature and a second feature that refer to two categories/two features, wherein the first feature may be one or more, and the second feature may also be one or more.

Further, in the following preferred embodiments, numerous specific details are set forth in order to provide a better understanding of the disclosure. It will be understood by those skilled in the art that the disclosure may be practiced without some of the specific details. In some instances, methods, means, elements, and circuits well known to those skilled in the art have not been described in detail, so as not to obscure the subject matter of the disclosure.

In an application scenario of information processing, taking a vehicle-mounted terminal as an example, along with the year-by-year increase of automobile ownership, traffic is more and more complex and larger and larger parking lots appear, so that when people travel, they face problems that firstly parking lots cannot be found, and secondly, even a parking lot is found despite all troubles, a parking space cannot be found. With respect to many large parking lots (such as a parking lot of IKEA), there are a large number of vehicles around the outside of the mall to find the entrance of the parking lot every day, and there are also a large number of vehicles going around the inside of the parking lot to find a parking space, so it is necessary to carry out convenient and efficient navigation processing on indoor and outdoor vehicles (inside and outside the parking lot).

However, in the process of driving a vehicle, a user needs to perform a series of complicated information processing switching on the aspects of parking planning and indoor and outdoor navigation of a parking lot. For example, if a user enters an indoor parking lot, the user needs to switch to a special application of the indoor parking lot to execute information processing related to the navigation to realize indoor navigation, so that the convenient and efficient navigation processing requirements cannot be met, and accordingly, the navigation processing efficiency is reduced.

In the process of driving a vehicle, in terms of parking planning and indoor and outdoor navigation of a parking lot, there is a need to provide the recommendation of a parking lot before driving, during driving and after driving for a user through a map application, so that the user can find a suitable parking lot conveniently. Then, after the user drives into a parking lot, a special application (a third-party application owned by the parking lot) of the parking lot needs to be used. For example, an operator of the parking lot attaches a QR code in the parking lot to enable the user to open or download one official account corresponding to the third-party application or one mini-program of WeChat corresponding to the third-party application, or directly install the third-party application to realize the indoor parking space finding service through an official account, a mini-program or a third-party application. That is to say, an indoor and outdoor navigation and parking space inquiry service can be realized only by switching between a map application and a third-party application owned by a parking lot. But in this way, the split experience of navigation+parking space inquiry can be brought to the user, and a continuous user experience cannot be provided for the user due to switching among a plurality of applications, that is, an integrated indoor and outdoor navigation and parking space inquiry cannot be realized, and the user cannot be directly navigated to an idle parking space.

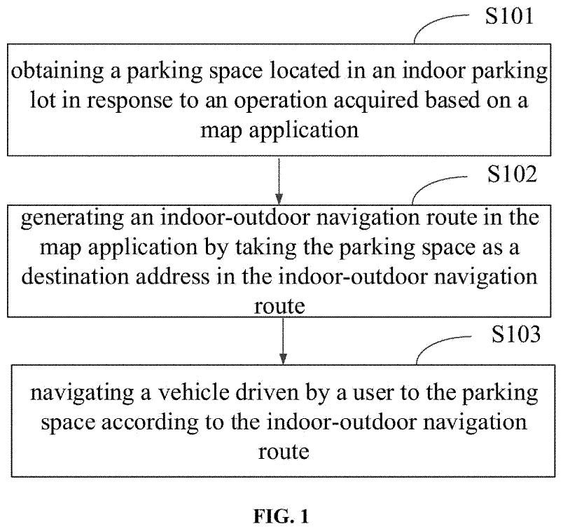

According to a first embodiment of the present disclosure, a navigation method is provided according to the embodiment of the disclosure. FIG. 1 is a schematic flowchart of a navigation method applied in a first embodiment of the present disclosure, and the method can be applied to a navigation apparatus. For example, in a case that the apparatus can be deployed to be executed by a terminal or a server or other processing equipment, a response operation interacting with a user, acquiring a parking space, a navigation planning and using the same map application throughout to realize seamless switching between indoor and outdoor navigation and the like can be executed. Among other things, the terminal may be user equipment (UE), mobile equipment, a cellular phone, a cordless phone, a personal digital assistant (PDA), handheld equipment, computing equipment, vehicle-mounted equipment, wearable equipment, etc. In some possible implementations, the method may also be implemented by processor calling computer-readable instructions stored in a memory. As shown in FIG. 1, The method includes:

S101: obtaining a parking space located in an indoor parking lot in response to an operation acquired based on a map application.

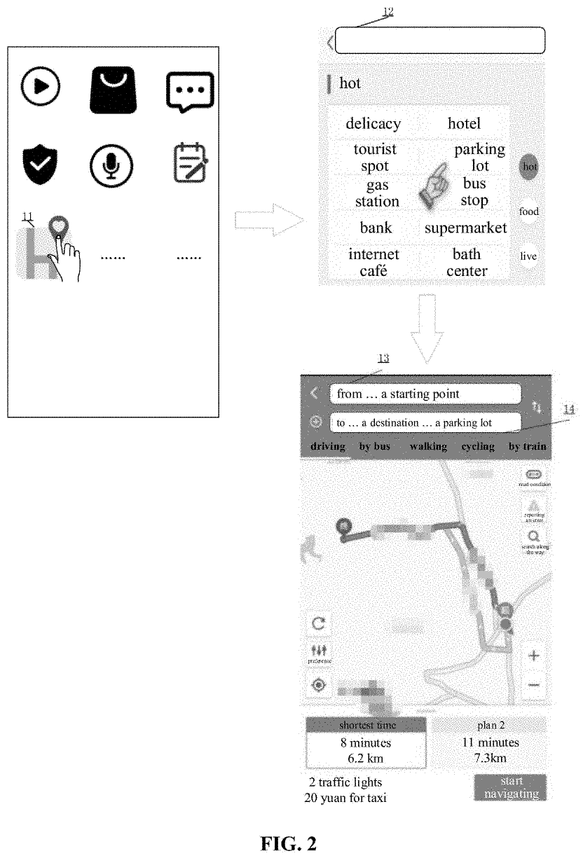

FIG. 2 is a schematic diagram of a navigation route planning including a parking space applied in the first embodiment of the present disclosure. In this example, as shown in FIG. 2, a plurality of applications may be installed on a mobile phone terminal, including a map application 11 which is touched and controlled to turn on to enter a planning mode of a navigation route. The parking lot at which the user wants to arrive can be queried in a first search box 12, or a recommended parking lot can be obtained by touching and controlling the “parking lot” and the like, and a parking space, such as an idle parking space, located in an indoor parking lot can be obtained.

S102: generating an indoor-outdoor navigation route in the map application by taking the parking space as a destination address in the indoor-outdoor navigation route.

FIG. 2 is a schematic diagram of a navigation route planning including a parking space applied to the first embodiment of the disclosure. In this example, as shown in FIG. 2, after the map application 11 being touched and controlled to turn on the map application 11 to enter a planning mode of a navigation route, a starting point (such as a home location or an office location) of a driving route of a user can be input in a second search box 13. It is also possible to input the destination (e.g., the queried parking lot at which the user wants to arrive, or the recommended parking lot can be obtained by touching and controlling the “parking lot”, and the like) of the driving route of the user in a third search box 14. In response to the starting point input operation at the second search box 13 and the destination input operation at the third search box 14, one or more indoor-outdoor navigation routes from the starting point to the destination may be generated in the map application. In FIG. 2, one indoor-outdoor navigation route is taken as an example, and the disclosure is not limited thereto.

S103: navigating a vehicle driven by a user to the parking space according to the indoor-outdoor navigation route.

In one example, the acquisition of indoor-outdoor navigation routes is not limited to the example shown in FIG. 2, and may include at least two application scenarios according to different operations responded to in S101. In the first application scenario, candidate idle parking spaces are displayed in one map application in response to query processing of a parking space. The operation can be as follows: the user selects a target parking space from the candidate idle parking spaces on the map application, and directly initiates a navigation operation to the target parking space. That is, the user can directly navigate the vehicle driven by the user to the target parking space (i.e., the selected idle parking space) using an end-to-end solution that navigates directly from the starting point to the destination (e.g., the target parking space). In the second application scenario, a navigation recommendation is triggered in response to a vehicle driven by a user approaching the indoor parking lot. The navigation recommendation includes a recommended idle parking space. The operation can be as follows: the user directly obtains the recommended idle parking space from the navigation recommendation, takes the recommended idle parking space as a target parking space, and directly initiates a navigation operation to the target parking space. That is, the user may use a dynamic recommendation scheme to a recommended destination (such as a target parking space), to navigate a vehicle driven by the user to the target parking space (i.e., the recommended idle parking space).

In the existing technology, some manufacturers (such as a third-party application of a parking lot or a shopping mall) are official accounts corresponding to the third-party application, mini-programs of WeChat corresponding to the third-party application or map applications, and the like called in the third-party application to be used for outdoor navigation. In response to detecting that a user is about to arrive at the parking lot, the manufacturers forcibly switches the user to the third-party application of the manufacturer through the official account, the mini-program of WeChat, and the like to realize the indoor and outdoor navigation of the “navigation+parking space”, so that the split experience of navigation+parking space query can be brought to the user, the continuous user experience cannot be provided for the user due to the switching among a plurality of applications, the integrated indoor and outdoor navigation and parking space query cannot be realized, and the user cannot be directly navigated to an idle parking space.

By applying the scheme of the present disclosure, a parking space located in an indoor parking lot can be obtained in response to an operation acquired based on a map application, and the parking space is taken as a destination address in the indoor-outdoor navigation route to generate an indoor-outdoor navigation route in the map application. According to the indoor-outdoor navigation route, a vehicle driven by a user can be navigated to the parking space. Due to the user interaction in response to the operation acquired based on the map application, the same map application on the terminal is used all the time based on the terminal (such as a mobile phone terminal of the user, or a vehicle-mounted terminal and the like), and a parking space located in an indoor parking lot can be conveniently obtained. A navigation route is planned for the destination address according to the parking space, so that indoor-outdoor navigation route can be obtained. Moreover, the map application is used all the time from the planning of the navigation route to the navigation processing without switching to other applications, so that the seamless switching of indoor and outdoor navigation is realized through the map application, the user interactive operation uses the same map application in the indoor and outdoor integrated navigation process without switching, and the navigation processing can be realized more conveniently and efficiently, thereby improving the processing efficiency of the navigation.

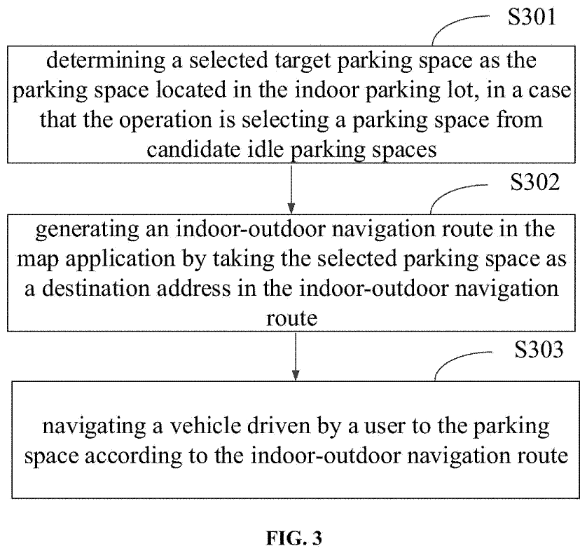

In a second embodiment of the present disclosure, a parking space can be selected on a map application based on a terminal (such as a mobile phone terminal of a user, or a vehicle-mounted terminal and the like) to directly initiate a navigation to the parking space. FIG. 3 is a schematic flowchart of a navigation method according to a second embodiment of the present disclosure. As shown in FIG. 3, the method includes:

S301, determining a selected target parking space as the parking space located in the indoor parking lot, in a case that the operation is selecting a parking space from candidate idle parking spaces.

In one example, a candidate idle parking space may be displayed in a map application in response to a query processing of the parking space, and in a case that a target parking space is selected, a navigation operation may also be initiated based on the target parking space.

With respect to displaying candidate idle parking spaces in a map application, a parking space of an indoor parking lot can also be specified in advance, that is, a user can check a target parking space which needs to be navigated to a parking lot through the map application in a navigation process (such as the navigation process that the user is about to enter the indoor parking lot but does not enter the indoor parking lot) before the navigation formation starts. When a target parking space in a parking space idle state and the idle state of the target parking space are queried, the navigation processing to the target parking space is directly initiated according to the target parking space specified (or referred to as selected) by the user in the navigation operation, that is to say, the target parking space can be taken as a destination address in an indoor-outdoor navigation route. After the indoor-outdoor navigation route is generated in the map application, the vehicle driven by the user is navigated to the target parking space according to the indoor-outdoor navigation route.

With respect to displaying a candidate idle parking space in a map application, an indoor parking lot can also be specified in advance, but the parking space is not selected, in which case a dynamic recommendation of the parking space, i.e., the automatic allocation of the recommended parking space, can be performed. In particular, if the user does not select a parking space and only selects a certain parking lot, the vehicle driven by the user can also be detected as near a parking lot (such as an entrance of the parking lot) using an automatic driving system navigated in conjunction with the map application, and at such time, a currently available idle parking space is recommended, so that the user can select an idle parking space as the target parking space according to the recommendation, initiate a navigation processing to the target parking space (i.e. setting the target parking space as a navigation end point of the indoor-outdoor navigation route), and then it is automatically switched from an outdoor navigation mode to an indoor navigation mode to guide the user to reach the target parking space.

S302: generating an indoor-outdoor navigation route in the map application by taking the selected target parking space as a destination address in the indoor-outdoor navigation route.

S303: navigating a vehicle driven by a user to the selected target parking space according to the indoor-outdoor navigation route.

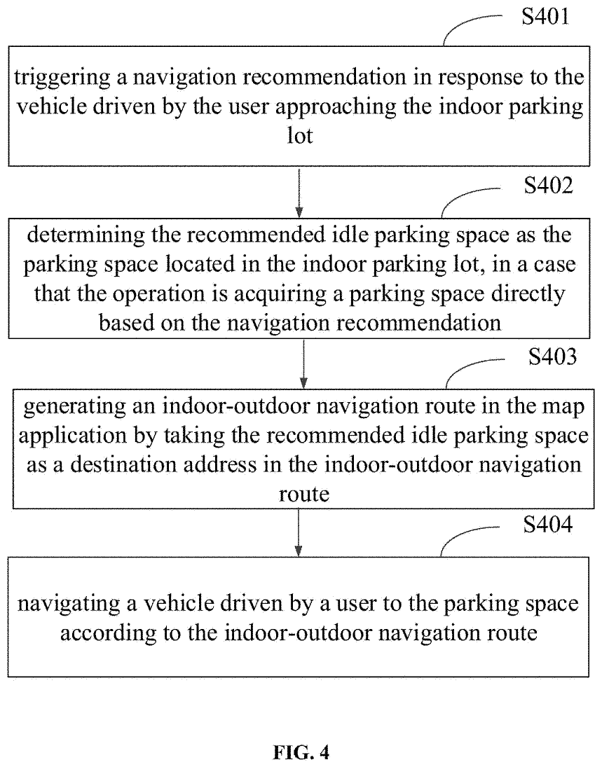

By applying the present disclosure, a selected target parking space is taken as a target address in an indoor-outdoor navigation route to plan a navigation route. The seamless switching of indoor and outdoor navigation is realized through the map application, and the user interactive operation uses the same map application in the indoor and outdoor integrated navigation process without switching, so that the navigation processing can be realized more conveniently and efficiently, thereby improving the processing efficiency of the navigation. In a third embodiment of the application, based on a terminal (such as a mobile phone terminal of a user, or a vehicle-mounted terminal and the like), a destination parking lot can be navigated to, one idle parking space in a parking lot is dynamically recommended through the map application, and the navigation to the parking space is initiated according to the dynamic recommendation. FIG. 4 is a schematic flowchart of a navigation method according to a third embodiment of the present disclosure. As shown in FIG. 4, the method includes:

S401: triggering a navigation recommendation in response to the vehicle driven by the user approaching the indoor parking lot.

In one example, the navigation recommendation includes a recommended idle parking space.

S402: determining the recommended idle parking space as the parking space located in the indoor parking lot, in a case that the operation is acquiring a parking space directly based on the navigation recommendation.

In one example, the driving position of a vehicle driven by a user may be monitored during a navigation process (e.g., a navigation process in which the user is about to enter an indoor parking lot, but does not enter the indoor parking lot). For example, the user may view the positional relationship between a vehicle that needs the user to drive and a nearby parking lot through the map application. If there is an idle parking space in the nearby parking lot, the navigation recommendation for idle parking spaces in the parking lot may be initiated to prompt the user for a corresponding selection. The user receives the recommended idle parking space, selects the parking space and initiates the navigation operation to the idle parking space. The user directly initiates the navigation processing to the idle parking space according to the idle parking space selected by the recommendation in the navigation operation, that is to say, the idle parking space can be taken as a destination address in an indoor-outdoor navigation route. After the indoor-outdoor navigation route is generated in the map application, the vehicle driven by the user is navigated to the idle parking space according to the indoor-outdoor navigation route.

In one example, an indoor parking lot may also be recommended, but the parking space is not recommended, in which case the dynamic recommendation of the parking space, i.e. the automatic allocation of the recommended parking space, can be performed. In particular, if a user does not recommend a parking space, but only a certain parking lot, a vehicle driven by the user can also be detected as near the parking lot (such as an entrance of the parking lot) using an automatic driving system navigated in conjunction with the map application, and at such time, a currently available idle parking space is recommended, so that the user can select an idle parking space as the target parking space according to the recommendation, initiate the navigation processing to the target parking space (i.e. setting the target parking space as a navigation end point of the indoor-outdoor navigation route), and then it is automatically switched from an outdoor navigation mode to an indoor navigation mode, to guide the user to reach the target parking space.

S403: generating an indoor-outdoor navigation route in the map application by taking the recommended idle parking space as a destination address in the indoor-outdoor navigation route.

S404: navigating a vehicle driven by a user to the recommended idle parking space according to the indoor-outdoor navigation route.

According to the present disclosure, a recommended parking space is taken as a target address in an indoor-outdoor navigation route to plan a navigation route. The seamless switching of indoor and outdoor navigation is realized through the map application, and the user interactive operation uses the same map application in the indoor and outdoor integrated navigation process without switching, so that the navigation processing can be realized more conveniently and efficiently, thereby improving the processing efficiency of the navigation.

In one implementation mode, the method further includes: switching between an outdoor navigation mode and an indoor navigation mode according to the indoor-outdoor navigation route, and a positional relationship between the vehicle driven by the user and the indoor parking lot. Switching between an outdoor navigation mode and an indoor navigation mode includes at least one of short-distance communication technologies such as Bluetooth, Wireless Fidelity (WWI), Global Positioning System (GPS), Ultra-Wideband (UWB), and the like. Correspondingly, the seamless switching realized by using the short-distance communication technologies can be as follows: in a case that a user is detected to be near an entrance of a parking lot or within the range of nearing a shopping mall where the parking lot is located according to the GPS positioning, that is, the detection range is reduced through the GPS positioning, an indoor positioning signal source of the short-distance communication is further detected. For example, the case that a user is about to enter an indoor parking lot can be accurately detected according to different short-distance communication means with different characteristics (such as bands, frequencies, and the like of the short-distance communication) of Bluetooth, WIFI, GPS, UWB and the like. Then the map application on a terminal (such as a mobile phone terminal of a user, or a vehicle-mounted terminal and the like) can be automatically switched from an outdoor driving navigation mode to an indoor driving navigation mode. That is, an indoor driving navigation function is provided, and the user does not need to switch among a plurality of applications or the indoor and outdoor navigation systems, thereby making it possible to realize the convenient and efficient seamless switching of indoor and outdoor navigation modes by applying the scheme of the present disclosure.

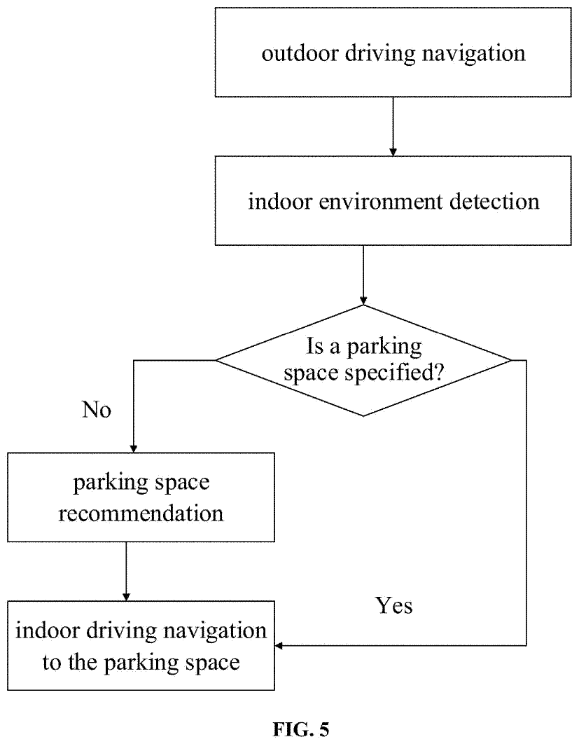

In a fourth embodiment of the present disclosure, FIG. 5 is a schematic diagram of an application example of a navigation method according to a fourth embodiment of the present disclosure. As shown in FIG. 5, by using the processing flow of the application example, an indoor and outdoor integrated driving navigation recommendation can be realized. In one map application, a user can select a parking space on a map to directly initiate the navigation to the parking space, to directly navigate to the parking space from a departure place of the user. Tt is also possible that in a case that a user is about to navigate to a destination parking lot, one idle parking space in the parking lot is dynamically recommended, and a navigation route to the parking space is planned, which includes:

1. Route planning is performed for a driving navigation route from a starting point to an idle parking space to obtain an indoor-outdoor navigation route, and the outdoor driving navigation is started based on the indoor-outdoor navigation route.

According to one manner, the parking space of a parking lot and the idle state of the parking space can be viewed in a map application to obtain an idle parking space. The idle parking space is set as a navigation destination to obtain an indoor-outdoor navigation route, the navigation to the idle parking space can be directly initiated, and in response to determining that a switching of the indoor and outdoor navigation is triggered, the indoor driving navigation mode can be automatically switched to, so that a user is guided to the parking space.

According to another manner, an automatic allocation of a parking space may be recommended. If a user does not select a parking space and only selects a certain parking lot, the vehicle-mounted navigation system recommends a currently available idle parking space, in response to detecting that the user is near the entrance of the parking lot, sets the idle parking space as a navigation destination to obtain an indoor-outdoor navigation route, and automatically switches to the indoor driving navigation mode to guide the user to the parking space, in response to determining that the switching of the indoor and outdoor navigation is triggered.

2. An indoor environment detection can be performed to switch the indoor and outdoor driving navigation. In a case that a user is near the entrance of a parking lot, a vehicle-mounted navigation system based on a map application in a terminal (a vehicle-mounted terminal or a mobile phone terminal and the like) can detect that the user is about to enter the idle parking space in the indoor parking lot by means of Bluetooth, WIFI, GPS, UWB, 5G positioning and the like. The vehicle-mounted navigation system can be automatically switched from the outdoor driving navigation mode to the indoor driving navigation mode, namely an indoor driving navigation function is provided, and the user does not need to switch among a plurality of applications or systems.

3. An indoor driving navigation is used in an indoor parking lot. By installing Beacon (a beacon base station supporting a low-power-consumption Bluetooth technology) or UWB equipment or 5G base station and like instruments supporting the short-distance communication technology in a parking lot, and meanwhile, with possible usage of a manner integrating fingerprint positioning, triangular positioning, inertial navigation and the like, an indoor positioning and driving navigation of the parking lot are realized.

4. It is determined whether a parking space is an idle parking space which is already specified in an indoor-outdoor navigation route. If so, the idle parking space is navigated to according to an indoor driving navigation. If not, it indicates that a user does not select the parking space, and only selects a certain parking lot, and in such case, the vehicle-mounted navigation system detects that the user is near an entrance of the parking lot, the currently available idle parking space is automatically allocated and recommended for the user, the idle parking space is set as a navigation destination, and the indoor driving navigation mode is automatically switched to, so that the user is guided to the idle parking space.

By applying the present application example, in one map application, a user can select a parking space on the map to directly initiate navigation to the parking space, so that the user can be directly navigated to the parking space from a departure place. It is also possible to dynamically recommend one idle parking space within the parking lot and plan a navigation route to the parking space, in a case that a user is about to navigate to the destination parking lot. By using the two manners, the problem that a user looks for a parking lot and a parking space is solved, and a continuous navigation experience is brought to the user.

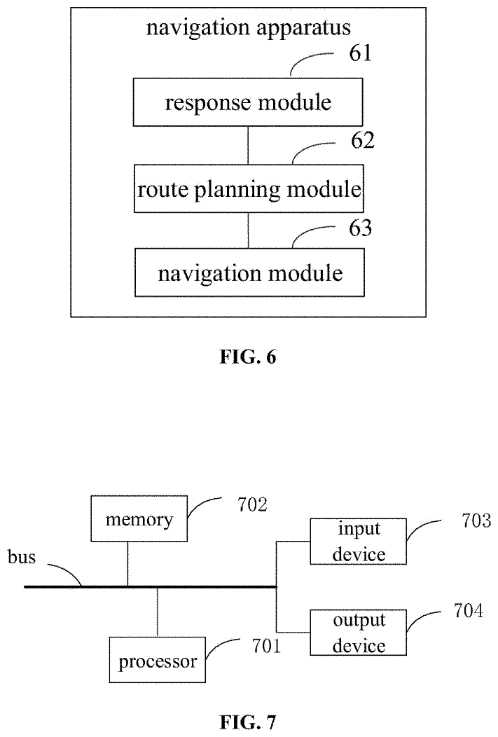

In a fifth embodiment of the present disclosure, FIG. 6 is a schematic structural diagram showing a navigation apparatus according to a fifth embodiment of the present disclosure. It is provided a navigation apparatus, as shown in FIG. 6, the apparatus includes: a response module 61 for obtaining a parking space located in an indoor parking lot in response to an operation acquired based on a map application; a route planning module 62 for generating an indoor-outdoor navigation route in the map application by taking the parking space as a destination address in the indoor-outdoor navigation route; and a navigation module 63 for navigating a vehicle driven by a user to the parking space according to the indoor-outdoor navigation route.

In an implementation, the response module is used for determining a selected target parking space as the parking space located in the indoor parking lot, in a case that the operation is selecting a parking space from candidate idle parking spaces.

In an implementation, a query module is further included, which is used for displaying the candidate idle parking spaces in the map application in response to a query processing of the parking space; wherein the route planning module is configured for initiating a navigation operation based on the selected target parking space, in a case that the selected target parking space is determined.

In an implementation, a navigation recommendation module is further included, which is used for triggering a navigation recommendation in response to the vehicle driven by the user approaching the indoor parking lot.

In an implementation, the navigation recommendation includes a recommended idle parking space; and the response module is configured for determining the recommended idle parking space as the parking space located in the indoor parking lot, in a case that the operation is acquiring a parking space directly based on the navigation recommendation.

In an implementation, a navigation switching module is further included, which is used for switching between an outdoor navigation mode and an indoor navigation mode according to the indoor-outdoor navigation route, and a positional relationship between the vehicle driven by the user and the indoor parking lot.

The function of each module in each apparatus of embodiments of the present disclosure can be referred to corresponding descriptions in the above-mentioned method, which will not be described in detail herein.

According to an embodiment of the present disclosure, an electronic device, and a readable storage medium are provided in the present disclosure.

As shown in FIG. 7, it is a block diagram of an electronic device for implementing a navigation method of an embodiment of the present disclosure. Electronic apparatuses are intended to represent various forms of digital computers, such as laptop computers, desktop computers, workbenches, personal digital assistants, servers, blade servers, mainframe computers, and other suitable computers. Electronic apparatuses may also represent various forms of mobile devices, such as personal digital assistants, cellular phones, smart phones, wearable devices, and other similar computing devices. The components shown herein, their connections and relationships, and their functions are merely examples, and are not intended to limit the implementation of the present disclosure described and/or claimed herein.

As shown in FIG. 7, the electronic device includes: one or more processors 701, memory 702, and interfaces for connecting various components, including high-speed interface and low-speed interface. The various components are interconnected using different buses and may be installed on a common motherboard or otherwise as desired. The processor may process instructions for execution within a classical computer, including instructions stored in the memory or on the memory to display graphical information of the GUI on an external input/output device, (such as display equipment coupled to the interface). In other implementation modes, multiple processors and/or multiple buses may be used with multiple memories and multiple memories, if desired. Also, multiple classical computers may be connected, each piece of equipment providing some of the necessary operations (e.g., as an array of a server, one set of blade servers, or a multiprocessor system). An example of one processor 701 is shown in FIG. 7.

The memory 702 is a non-transitory computer-readable storage medium provided herein. Where the memory stores an instruction executable by at least one processor to cause the at least one processor to execute the navigation method provided herein. The non-transitory computer-readable storage medium of the present disclosure stores computer instructions for causing a computer to execute the navigation method provided herein.

The memory 702, as one non-transitory computer-readable storage medium, may be used to store non-transitory software programs, non-transitory computer-executable programs, and modules, such as program instructions/modules (e.g., the response module, the route planning module, the navigation module, etc., shown in FIG. 6) corresponding to the navigation method in the embodiment of the disclosure. The processor 701 executes various functional applications and data processing of the server, i.e., implementing the navigation method in the above-described method embodiment, by running non-transient software programs, instructions, and modules stored in the memory 702.

The memory 702 may include a storage program area and a storage data area. The storage program area may store an operating system and an application program required for at least one function. The storage data area may store data or the like created according to the usage of the electronic device. In addition, the memory 702 may include high-speed random-access memory, and may also include non-transitory memory, such as at least one disk storage component, flash memory component, or other non-transitory solid state storage components. In some embodiments, the memory 702 optionally includes memory remotely provided relative to the processor 701 The remote memory may be connected to the electronic device via a network. Instances of such networks include, but are not limited to, the Internet, intranets, local area networks, mobile communication networks, and combinations thereof.

The electronic device of the navigation method may further include: an input device 703 and an output device 704. The processor 701, memory 702, input device 703, and output device 704 may be connected by a bus or other means, as exemplified by a bus connection in FIG. 7.

The input device 703 may receive input numeric or character information and generate key signal inputs related to user settings and functional controls of the sensed electronic equipment, such as input devices of touch screens, keypads, mice, track pads, touch pads, pointing sticks, one or more mouse buttons, track balls, joysticks, etc. The output device 804 may include display devices, auxiliary lighting devices (e.g., LEDs), tactile feedback devices (e.g., vibration motors), and the like. The display device may include, but is not limited to, a liquid crystal display (LCD), a light emitting diode (LED) display, and a plasma display. In some embodiments, the display device may be a touch screen.

Various embodiments of the systems and techniques described herein may be implemented in digital electronic circuit systems, integrated circuit systems, disclosure specific ASICs (disclosure specific integrated circuits), computer hardware, firmware, software, and/or combinations thereof. These various embodiments may be embodied in one or more computer programs, which can be executed and/or interpreted on a programmable system including at least one programmable processor, which can be a dedicated or general-purpose programmable processor, and can receive data and instructions from, and transmit data and instructions to, a memory system, at least one input device, and at least one output device, and the at least one output device.

These computing programs (also referred to as programs, software, software disclosures, or code) include machine instructions of a programmable processor, and may be implemented using high-level procedural and/or object-oriented programming languages, and/or assembly/machine languages. As used herein, the terms “machine-readable medium” and “computer-readable medium” refer to any computer program product, equipment, and/or device (e.g., magnetic disk, optical disk, memory, programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

To provide interaction with a user, the systems and techniques described herein may be implemented on a computer having: a display device (e.g., a CRT (cathode ray tube) or LCD (liquid crystal display) monitor) for displaying information to a user; and a keyboard and a pointing device (e.g., a mouse, or a trackball) through which a user can provide input to the computer. Other types of devices may also be used to provide interaction with a user. For example, the feedback provided to the user may be any form of sensory feedback (e.g., visual feedback, auditory feedback, or tactile feedback); and input from the user may be received in any form, including acoustic input, voice input, or tactile input.

The systems and techniques described herein may be implemented in a computing system that includes a background component (e.g., as a data server), or a computing system that includes a middleware component (e.g., an disclosure server), or a computing system that includes a front-end component (e.g., a user computer having a graphical user interface or a web browser, wherein a user may interact with embodiments of the systems and techniques described herein through the graphical user interface or the web browser), or in a computing system that includes any combination of such background components, middleware components, or front-end components. The components of the system may be interconnected by any form or medium of digital data communication (e.g., a communication network). Examples of communication networks include: local Area Networks (LANs), Wide Area Networks (WANs), and the Internet.

A computer system may include a client and a server. The client and server are typically remote from each other and typically interact through a communication network. The relationship of the client and the server is generated by computer programs running on the respective computer and having a client-sewer relationship with each other.

By applying the present disclosure, a parking space located in an indoor parking lot can be obtained in response to an operation acquired based on a map application, and the parking space is taken as a destination address in an indoor-outdoor navigation route to generate the indoor-outdoor navigation route in the map application. According to the indoor-outdoor navigation route, a vehicle driven by a user can be navigated to the parking space. Due to the user interaction in response to the operation acquired based on the map application, a parking space located in an indoor parking lot can be conveniently obtained. A navigation route is planned for the destination address according to the parking space, so that indoor-outdoor navigation route can be obtained. Moreover, the map application is used all the time from the planning of the navigation route to the navigation processing without switching to other applications, so that the seamless switching of indoor and outdoor navigation is realized through the map application. The user interaction operation, the convenient and efficient navigation processing mode can improve the processing efficiency of the navigation.

It should be understood that the various forms of flow, reordering, adding or removing steps shown above may be used. For example, the steps recited in the present disclosure may be performed in parallel or sequentially or may be performed in a different order, so long as the desired results of the technical solutions disclosed in the present disclosure can be achieved, and no limitation is made herein.

The above-mentioned embodiments are not to be construed as limiting the scope of the present disclosure. It will be apparent to those skilled in the art that various modifications, combinations, sub-combinations and substitutions are possible, depending on design requirements and other factors. Any modifications, equivalents, and improvements within the spirit and principles of this disclosure are intended to be included within the scope of this disclosure.

What is claimed is:

1. A navigation method, comprising:
obtaining a parking space located in an indoor parking lot in response to an operation acquired based on a map application;
generating an indoor-outdoor navigation route in the map application by taking the parking space as a destination address in the indoor-outdoor navigation route; and
navigating a vehicle driven by a user to the parking space according to the indoor-outdoor navigation route.

2. The method of claim 1, wherein the obtaining the parking space located in the indoor parking lot in response to the operation acquired based on the map application comprises:
determining a selected target parking space as the parking space located in the indoor parking lot, in a case that the operation is selecting a parking space from candidate idle parking spaces.

3. The method of claim 2, further comprising:
displaying the candidate idle parking spaces in the map application in response to a query processing of the parking space; and
initiating a navigation operation based on the selected target parking space, in a case that the selected target parking space is determined.

4. The method of claim 1, further comprising:
triggering a navigation recommendation in response to the vehicle driven by the user approaching the indoor parking lot.

5. The method of claim 4, wherein the navigation recommendation comprises a recommended idle parking space; and
the obtaining the parking space located in the indoor parking lot in response to the operation acquired based on the map application comprises:
determining the recommended idle parking space as the parking space located in the indoor parking lot, in a case that the operation is acquiring a parking space directly based on the navigation recommendation.

6. The method of claim 1, further comprising:
switching between an outdoor navigation mode and an indoor navigation mode according to the indoor-outdoor navigation route, and a positional relationship between the vehicle driven by the user and the indoor parking lot.

7. The method of claim 2, further comprising:
switching between an outdoor navigation mode and an indoor navigation mode according to the indoor-outdoor navigation route, and a positional relationship between the vehicle driven by the user and the indoor parking lot.

8. The method of claim 3, further comprising:
switching between an outdoor navigation mode and an indoor navigation mode according to the indoor-outdoor navigation route, and a positional relationship between the vehicle driven by the user and the indoor parking lot.

9. The method of claim 4, further comprising:
switching between an outdoor navigation mode and an indoor navigation mode according to the indoor-outdoor navigation route, and a positional relationship between the vehicle driven by the user and the indoor parking lot.

10. The method of claim 5, further comprising:
switching between an outdoor navigation mode and an indoor navigation mode according to the indoor-outdoor navigation route, and a positional relationship between the vehicle driven by the user and the indoor parking lot.

11. An electronic device, comprising:
at least one processor; and
a memory communicatively connected to the at least one processor, wherein
the memory stores instructions executable by the at least one processor, and the instructions are executed by the at least one processor to enable the at least one processor to:
obtain a parking space located in an indoor parking lot in response to an operation acquired based on a map application:
generate an indoor-outdoor navigation route in the map application by taking the parking space as a destination address in the indoor-outdoor navigation route: and
navigate a vehicle driven by a user to the parking space according to the indoor-outdoor navigation route.

12. The electronic device according to claim 11, wherein the instructions are executed by the at least one processor to further enable the at least one processor to:
determine a selected target parking space as the parking space located in the indoor parking lot, in a case that the operation is selecting a parking space from candidate idle parking spaces.

13. The electronic device according to claim 12, wherein the instructions are executed by the at least one processor to further enable the at least one processor to:
display the candidate idle parking spaces in the map application in response to a query processing of the parking space; and
initiate a navigation operation based on the selected target parking space, in a case that the selected target parking space is determined.

14. The electronic device according to claim 11, wherein the instructions are executed by the at least one processor to further enable the at least one processor to:
trigger a navigation recommendation in response to the vehicle driven by the user approaching the indoor parking lot.

15. The electronic device according to claim 14, wherein the navigation recommendation comprises a recommended idle parking space; and the instructions are executed by the at least one processor to further enable the at least one processor to:
determine the recommended idle parking space as the parking space located in the indoor parking lot, in a case that the operation is acquiring a parking space directly based on the navigation recommendation.

16. The electronic device according to claim 11, wherein the navigation recommendation comprises a recommended idle parking space; and the instructions are executed by the at least one processor to further enable the at least one processor to:
switch between an outdoor navigation mode and an indoor navigation mode according to the indoor-outdoor navigation route, and a positional relationship between the vehicle driven by the user and the indoor parking lot.

17. A non-transitory computer-readable storage medium storing computer instructions, wherein the computer instructions, when executed by a computer, cause the computer to:
obtain a parking space located in an indoor parking lot in response to an operation acquired based on a map application;
generate an indoor-outdoor navigation route in the map application by taking the parking space as a destination address in the indoor-outdoor navigation route; and
navigate a vehicle driven by a user to the parking space according to the indoor-outdoor navigation route.

18. The non-transitory computer-readable storage medium according to claim 17, wherein the computer instructions, when executed by a computer, further cause the computer to:
determine a selected target parking space as the parking space located in the indoor parking lot, in a case that the operation is selecting a parking space from candidate idle parking spaces.

19. The non-transitory computer-readable storage medium according to claim 18, wherein the computer instructions, when executed by a computer, further cause the computer to:
display the candidate idle parking spaces in the map application in response to a query processing of the parking space; and
initiate a navigation operation based on the selected target parking space, in a case that the selected target parking space is determined.

20. The non-transitory computer-readable storage medium according to claim 17, wherein the computer instructions, when executed by a computer, further cause the computer to:
trigger a navigation recommendation in response to the vehicle driven by the user approaching the indoor parking lot.
